(19) United States
(12) Patent Application Publication
(10) Pub. No.: US 2012/0298126 A1
(43) Pub. Date: Nov. 29, 2012

(54) Phase Transition Compositions Used to Impart Reduced Ignition Propensity to Smoking Articles

(75) Inventors: Alexander J. Dyakonov, Greensboro, NC (US); Steven E. Brown, Oak Ridge, NC (US); Luis A. Sanchez, Greensboro, NC (US)

(73) Assignee: Lorillard Tobacco Company, Greensboro, NC (US)

(21) Appl. No.: 13/415,728

(22) Filed: Mar. 8, 2012

Related U.S. Application Data
(60) Provisional application No. 61/450,375, filed on Mar. 8, 2011.

(51) Int. Cl. C09K 21/14; C10L 10/00; C10G 73/00; A24D 1/02

(52) U.S. Cl. 131/365; 252/602; 585/9; 208/24

(57) ABSTRACT

A composition for imparting reduced ignition propensity properties to a smoking article by treating the smoking article wrapper. The composition comprising at least one phase transition substance which, upon being subjected to the heat of the smoking article burning firecone, physically transforms and at least partially fills the pores of the smoking article wrapper to reduce the permeability of the wrapper in the vicinity of the burning firecone. The reduced permeability of the wrapper in the vicinity of the firecone will permit sufficient air flow to sustain free burn, but, when the smoking article is placed on a substrate, the reduced permeability of the wrapper imparts reduced ignition propensity such that there is insufficient air flow to sustain combustion of the firecone or insufficient air flow to sustain an intensity of the burning firecone necessary to ignite the substrate.

This application claims priority to U.S. application No. 61/450,375 filed Mar. 8, 2011, the entire contents of which is incorporated herein by reference.

### FIELD OF THE INVENTION

The present invention relates generally to smoking articles having reduced ignition propensity property when in contact with an ignition-prone substrate and acceptable free burn property when the article is freely suspended in a static state and, more particularly, to phase transition compositions applied to or integral with the smoking article wrapper to enhance both of these properties.

### BACKGROUND

The science of the ignition propensity in the cigarette-substrate system is based mostly on the thermo-physical properties of cigarette smoldering. Smoldering is a slow and flameless combustion, which progresses at relatively low temperature through a lit tobacco rod in a free-burning and not actively smoked cigarette. The smolder is sustained by the heat generated by oxidative degradation of tobacco and paper at the thermal front, or burning ember, of the cigarette. The burning cigarette requires a supply and transfer of air to the coal as oxygen within the tobacco rod is depleted. Oxygen is transferred from surrounding air by diffusion across the paper wrapper, and convection through the spaces between discrete pieces of tobacco in the rod.

Under some circumstances, cigarettes may ignite fire-prone substrates, e.g., upholstery fabric, if the cigarette is laid on or accidentally contacted with the substrate. Accordingly, there is an ongoing effort in the tobacco industry to produce cigarettes having reduced ignition propensity, such that when the cigarette contacts a fire-prone substrate the cigarette tends to either self-extinguish or not ignite the substrate.

Although the industry has made significant progress in reducing ignition propensity of cigarette, these benefits have generally resulted in lower consumer acceptability with regard to the performance of the cigarette. Factors affecting consumer acceptability include the ability of the cigarette to free burn in a static state as well as cigarette product appearance (e.g., having a pleasing and consistent wrapper and ash character). Indeed, one of the challenges facing the industry is the ability to produce customer acceptable cigarettes having both reduced ignition propensity and acceptable free burn properties, altogether characterized by a LIP performance index, or a probability to have cigarette successfully passing both IP and FB tests (LIP performance index=IP×FB). It will be understood that the LIP performance index is calculated based on the FB and reduced IP performance characteristics of a sample population of at least 10 cigarettes, and preferably a sample population of 20 or 40 cigarettes. Thus, it is desirable to enhance both the LIP performance index and consumer acceptability characteristics of so-called “fire-safe cigarettes,” such that they tend to free burn as long as they are held free in the air, but, when dropped on substrate, they tend to self-extinguish on substrate.

Prior efforts for making cigarettes with reduced ignition propensity properties have focused on the use of wrappers with discrete areas such as printed starch bands that provide fixed regions of reduced air permeability along the length of the cigarette. Accordingly, one area of improvement with regard to reduced ignition propensity property involves providing a cigarette with high LIP performance index along its entire length, not only at discrete banded regions on the tobacco wrapper. One of the challenges presented for such a reduced ignition propensity cigarette, however, is providing the necessary wrapper air permeability that supports the combustion processes while also maintaining the physical integrity and acceptable appearance of the smoking article.

Other prior art for making cigarettes with reduced ignition propensity properties involved incorporating various substances in the cigarette wrapper, including: (1) burn altering chemical additives which can either accelerate or retard the combustion, such as potassium citrate and other alkali metal salts, metals, or metal oxides, (2) gas permeability reducing constituents, such as additional paper, cellulose aqueous film-forming solutions (e.g., alginate, starch, tapioca, carrageenan gum, guar gum, pectin), or and/or (3) various other polymers. These additives are used either singly or in conjunction with paper permeability modifiers that alter the paper nature. For example, an earlier reduced ignition propensity cigarette design added potassium citrate in discrete amounts to a paper that had low diffusive capacity. The potassium salts caused the paper cellulose structure to degrade at lower temperatures; therefore this cigarette had a wider paper burn line which allows more oxygen to reach the coal and sustain smoldering combustion.

The prior art also discloses the use of various materials to modify the ignition propensity of the conventional cigarette papers. These materials include polymer coatings with thermoplastic properties in the form of bands on the outer surface of the cigarette wrapper. Thermoplastic polymers such as hydroxylpropyl cellulose and ethyl cellulose have been applied to cigarette paper for the purpose of reducing cigarette burn rate. Although such wrappers could be used for making cigarettes with modified cigarette burn rate, these wrappers were made using organic solvents with the intention of avoiding physical disruptions to the cigarette paper that rendering this method of wrapper modification to be unusable during production. Furthermore, the use of organic solvents in this application can degrade the smoking article appearance because it makes the paper translucent and tobacco visible through it.

There remains a need in the cigarette industry to avoid organic solvent based polymers because these solvents add complex handling and suffer of potential health and fire hazards in on-line manufacturing processes. They also have the risk of residual solvents remaining in the paper that might affect health and narcoleptic smoking article properties. Therefore the use of organic solvents uses separate off-line printing processes to make modified cigarette papers.

A thermo-chemical activation of specific additives for ignition propensity is also taught in the art: WO 02/43513 A1 to Dyakonov and Grider teaches the use of high temperature cross-linking of water-soluble polymers as well as of low molecular weight polyolefins for low ignition propensity applications. These materials could be applied to the aqueous furnish of cellulosic pulp during the paper making operation, or applied on the base paper by printing-like process. These additives bind to the cellulosic substrate and to each other and to the paper at the elevated temperatures reached by the burning cigarettes so they substantially reduce the porosity of the paper during smoking. This application teaches also the use of cellulosic reactive materials such as PMVEMA and polyacrylic acid.

Other teachings disclose use of water solutions of hydroxypropyl cellulose to make coatings on the cigarette wrapper. Because this latest method uses a banding approach with discrete coating zones, it is unable to provide a 100% LIP performance index because the static burn rate suffers. In addition, the application of aqueous polymer solutions to the cigarette wrappers is problematic because the aqueous solutions significantly reduce the strength of the paper, cause the paper to pucker in the coated areas; and cigarettes made with these wrappers have non-uniform and unappealing outer surfaces. Accordingly, there is a need for compositions which require minimal amounts of water and which may be applied to the entire surface of a cigarette wrapper for imparting reduced ignition propensity properties without impairing (1) the wrapper permeability and appearance or (2) cigarette free burn characteristics.

### SUMMARY OF THE INVENTION

The present invention is directed to phase transition compositions for altering or modifying the physical and/or chemical nature of the semi-porous membranes, i.e. smoking article wrappers, when exposed to an environmental stimulus such as temperature or pressure upon use. In such a case, for example, the gas permeability of the membrane can be altered during usage to reduce the quantity of gas or air passing through the membrane.

According to one embodiment of the present invention the phase transition materials (PTM), such as waxes, are applied to a cigarette wrapper to provide a desirable reduced Ignition Propensity (IP) effect while maintaining free burn performance. Applicants have found that the method by which the PTM is applied greatly affects the overall efficacy and performance of the new reduced IP technology. In this case, the efficiency is measured by the overall quantity of the PTM needed to reduce the air permeability to achieve the reduced IP effect, the rate at which the effect takes place, and the reproducibility (robustness) of the self extinguishing property of the smoking article.

Further aspects of the present invention include (1) the methods of application of PTMs to achieve an optimal reduced IP performance, (2) the relationships between the quantities of applied PTM, the applied patterns, and the paper characteristics and (3) the relevance of the chemical compositions of the PTM material and their special relevance to reduced IP performance.

### BRIEF DESCRIPTION OF THE DRAWINGS

The invention will be better understood after a reading of the following description of the preferred embodiments when considered with the drawings in which:

FIG. 1 is a schematic of a cigarette embodying the present invention, which illustrates how the PTM in conjunction with the cigarette fire cone forms a virtual band of decreased air permeability at the distal region of the ignited cigarette;

FIG. 2 is graph showing the overall LIP performance index of cigarettes with wrapper paper treated with water suspensions of PTMs;

FIG. 3 shows images of the transient band configuration in ignited cigarettes;

FIG. 4 is a chart showing the transient band width as a function of PTM melting temperature;

FIG. 5 is a chart showing the transient band width at various wax formulations;

FIG. 6 is graph showing the overall LIP performance index of cigarettes embodying the present invention with wrapper paper having different air permeability;

FIG. 7 shows images of cigarette wrapper paper for the diffusion of PTM through the paper;

FIG. 8 is a microscopy image of phase-separated polypropylene and carnauba PTM formulation according to the present invention on a 19 CU paper;

FIG. 9 is a SEM picture of the a PTM formulation according to the present invention having micronized powder of polypropylene dispersed in melted carnauba deposited on the paper;

FIG. 10 is chart illustrating the transient band width of cigarettes having wrappers treated with various PTM formulations according to the present invention;

FIG. 11 is graph showing the LIP performance index of cigarettes having wrappers treated with varying amounts of a different PTM formulations according to the present invention deposited from water suspensions and from hot melts;

FIG. 12 is a graph showing the viscosity of melted PTMs according to the present invention at different sheer rates;

FIG. 13 is a graph showing the relaxation times of melted PTMs according to the present invention;

FIG. 14 is a chart comparing the length of tobacco column burned until it self-extinguished for a prior art fixed starch banded cigarette and various embodiments of the present invention;

FIG. 15 is a graph showing the compatibility of various PTM blend compositions according to the present invention as a function of solidification temperature;

FIG. 16 is a graph showing the relationship between cigarette ignition propensity and the compatibility of the various PTM blend compositions from FIG. 2;

FIG. 17 is a graph showing the compatibility of various PTM blend compositions for achieving cigarette reduced ignition propensity as a function of DSC peaks;

FIG. 18 is graph showing the melting of carnauba-polyethylene-polypropylene PTM formulation in a 100° C. temperature range as monitored by DSC;

FIG. 19 shows a schematic mechanism of TPM/CO increase;

FIG. 20 shows a graph of TPM/CO ratio versus solanesol wax amount;

FIG. 21 shows a graph of TPM/CO versus wax amount of carnauba-polyethylene; and

FIG. 22 shows a graph of TPM/CO for 100% LIP cigarettes versus carnauba-polyethylene- and solanesol wax amount;

### DESCRIPTION OF THE PREFERRED EMBODIMENTS

Referring now to the drawings in general, it will be understood that the illustrations are for the purpose of describing preferred embodiments of the invention and are not intended to limit the invention thereto.

Exemplary smoking articles embodying the present invention may comprise tobacco blend, wrapped in an air-permeable paper of 10-100 Coresta Units, wherein the wrapper has been modified or treated with Phase Transition Material (PTM). Phase transition materials are understood to be materials that undergo phase changes when an intensive variable, i.e., temperature or pressure, change. Exemplary phase transitions include eutectic, peritectic, spinodal and other physical transformations were transitions are driven by intensive variable changes, but are predominantly those that possess a solid to liquid transition upon heating.

The applicants have discovered that PTMs, including natural waxes (e.g., paraffin, carnauba, beeswax, tobacco wax, solanesol), microcrystalline waxes and synthetic waxes (e.g., relatively low molecular weight hydrocarbon polymers such as 500-1000 or greater molecular weight, Mₙ, POLYWAX® polypropylene manufactured by Baker Petrolite or 3500-4500 molecular weight, Mₙ, polyethylene) impart reduced ignition propensity characteristics to cigarette papers, when PTMs are applied to provide patterned coverage over the entire surface of the cigarette paper and in a sufficient amount to alter the gas permeability of the paper upon phase transition, e.g., melting. It will be understood that other relatively low molecular weight polymers, including polypropylene and polyethylene substances, as well as other known synthetic waxes, may be suitable for use as PTMs according to the present invention. Other examples of PTMs include polyolefin wax, alkylene wax, Fischer Tropsch wax, jojoba wax, rice wax, montanic acid ester wax, castor wax, candelilla wax, spermaceti wax, Japan wax, aliphatic amide wax, linear polyester wax, branched polyester waxes, ester waxes is made from long chain fatty acids and alcohol or mixtures thereof PTMs is not limited to a single component. The PTM may include two or more components incorporated into water or a hot melt system formulation for this application. In this manner, the patterned layer near the fire cone melts and subsequently forms a continuous transient band via wicking into the paper substrate. Machine-made cigarettes embodying the present invention demonstrate that a wrapper treated with about 5 to about 35 weight percent of an individual PTM or combinations of two or more thereof (e.g., heterogeneous mixtures forming the non-continuous layer or coating on the paper) is effective to achieve 100% reduced ignition propensity performance while maintaining acceptable free burn performance in the smoking article.

An illustrative example of the present invention of a PTM formulation having more than two PTM components comprises 45-65% carnauba, 20-40% polyethylene with 3500-4500 molecular weight and 5-15% polypropylene with 500-1000 molecular weight. Applicants have found that this exemplary PTM formulation is particularly useful for application by random placement of 40-60 pL wax droplets of 12-15 weight % PTM on a 19 Coresta Unit cigarette paper wrapper having an average pore size of 1-1.5 microns. Those skilled in the art will appreciate that the particular components and amounts thereof used in a particular PTM formulation may vary depending on the porosity, pore size and pore distribution of the base paper, the tobacco fiber composition of the smoking article, as well as various manufacturing variables such as the type of manufacturing equipment, the production rate, etc.

The patterned layer of PTM may be applied uniformly along the entire surface of the cigarette wrapper such that the wrapper has a consistent concentration of PTM per unit area. Alternatively, the patterned layer of PTM may be applied in a manner to provide increased gradients of PTM concentration per wrapper unit area. For example, the portion of the wrapper forming the buccal or mouth end of the cigarette may have higher or lower concentrations of PTM per unit area than the portion of the wrapper forming the distal or ignited end of the cigarette. In addition, the overall PTM concentration may remain uniform or maybe be applied as bands or zones along the entire surface of the wrapper, while the proportion of the individual compositions of the PTM material vary from the wrapper portion forming the buccal end to wrapper portion forming the ignited end of the cigarette.

The PTM may comprise a single material or a composition of materials. Further, the PTM may be applied to the inner surface of the wrapper. Smoking articles according to the present invention self-extinguish when placed on substrate and continue to free burn when suspended in the air and not touching other surfaces, manifesting the property of reduced Ignition Propensity (IP) characterized by an overall LIP performance index of 90% and higher (LIP performance index=IP×FB).

Applicants have also found that the PTM content applied to the wrapper can be minimized by selecting PTMs that favorably interact with each other and the paper substrate upon melting as well as the disposition method.

Applicants also found that the particular composition of the PTM formulation applied to the cigarette wrapper is critical to manage and control the quality parameters of the resulting reduced ignition propensity cigarette, which include reduced ignition propensity, free burn, appearance of cigarette, smoke taste, smoke content, and time-to-extinguish. For example, too low as well as too high melting temperatures of PTM formulation would create an appearance problem.

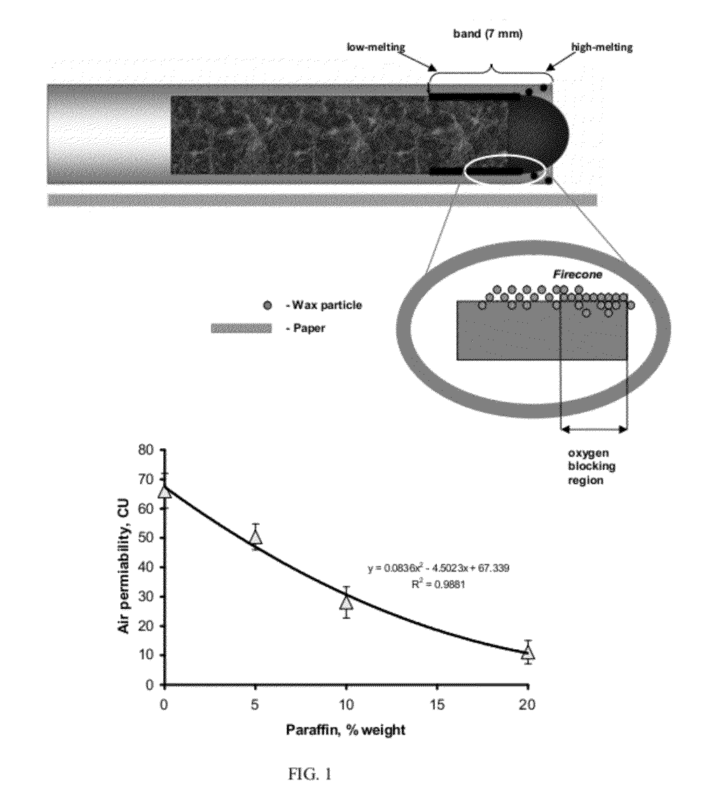

As shown in FIG. 1, the movement of the firecone propagates the melt of PTM formulation along the tobacco column wrapper, creating a transient band (TB) of PTM ahead of the firecone and therefore it changes the air permeability of the substrate. Furthermore, as also shown in FIG. 1, the amount of the PTM formulations deposited in the cigarette wrapper affect also the air permeability. Specifically, FIG. 1 demonstrates that varying the weight % of 100° C.-melted paraffin results in a decreased air permeability of the cigarette wrapper by 60 CU or more. Because the LIP performance index is a function of the column wrapper air permeability, the performance of transient band to provide reduced IP requires specific PTM compositions with well defined physical properties.

The applicants have also found that, in addition to the combinations of the original physical properties of ingredients, such as melting temperatures and heats of fusion, these compositions provide synergistic interactions between ingredients and also with the paper. These interactions affect the diffusion of melted PTMs through the paper, the width of transient band, the duration of PTM being in a liquid state, the cigarette appearance and the speed to achieve the LIP effect and, ultimately, the IP-FB pass rates and the quality of the cigarette smoke.

The selection of the PTM properties and PTMs themselves is based on the properties of cigarette paper and dynamic temperature profiles on smoldering cigarette. As illustrated in FIG. 1, applicants have found that the following three mechanisms of the transient band contribute to the reduced IP properties of cigarettes: (1) the mechanism of blocking air by the barrier of melted PTM, (2) the mechanism of chemical inhibition of combustion, and (3) the mechanism of absorption of combustion heat by melting PTM. Analysis showed that in most cases the concept of a transient band can be universally explained using the first mechanism, or blocking the air flow to the firecone. This is illustrated in FIG. 1 that shows a decrease in air permeability of a 70 CU paper when a fine paraffin powder was affixed in different amounts on paper and melted at 100° C.

The movement of the transient band along the firecone is caused by melting PTM formulation by the smoldering tobacco as the fire travels along the tobacco column. The progressing transient band could also be affected by wicking of the liquid PTMs in the same direction as the firecone and can be described by several scientific theories to predict movement of liquid media through porous materials. The width of transient band and associated reduced IP properties of cigarettes depend on (i) the duration of PTM being in a liquid state before incineration or solidification, (ii) the hydrophilicity of PTMs and (iii) the adhesion of the PTMs to the paper. However, improved reduced IP properties can occur at the expense of spoiling the cigarette appearance, for example, when cigarette paper becomes translucent in a large area or where heat is transported by a stream of smoke. Therefore, it is necessary to balance the various quality parameters attributable to the PTM formulations. To this end, applicants have discovered that a maximum reduced IP and optimum visual appearance of cigarette, speed to achieving reduced IP effect and processability of PTM-modified paper depend on the composition of PTM formulations, which usually requires more than one component.

The primary criteria for the selection of PTM formulations include: (1) providing sufficient adhesivity or film-forming properties of the melted PTM to create a transient band barrier to air flow through the cigarette wrapper; (2) maintaining the melting points between 60° C. and 200° C. to prevent premature melting of PTM below 60° C. (e.g., hot weather) as well as to prevent drastically changing the paper destruction process above 200° C. to provide good appearance for both the unburned paper and the char line; (3) minimizing the effect of the PTM formulations on the cigarette smoke composition, which could result from both combustion of the PTM in paper and altering combustion-pyrolysis of tobacco leading to affecting narcoleptic properties; (4) maintaining a narrow transient band appearance on the outer surface of the cigarette wrapper similar to that of conventional cigarettes; (5) providing a PTM formulation and its combustion products with an odorless (e.g., polyolefins) or pleasant odor (e.g., carnauba, low molecular weight polyethylene).

Applicants have found that PTMs, such as paraffin or carnauba, with low melting points (typically, below 90° C.) upon melting provide transient bands that largely extend downstream of the firecone. This helps to block the air access into the firecone from the cold region (i.e., the portion of the cigarette downstream the firecone), therefore promoting reduced IP property. In addition, PTMs, such as polyethylene, stearamide or polypropylene, with high melting points (typically, up to 200° C.) upon melting provide a transient band extending more upstream of firecone, or beyond the usual char line, hence blocking high heat of the burning firecone from reaching the substrate, thus preventing the latter from catching fire.

The PTM formulations may also contain combustion-regulating additives, both retardants and promoters, such as clays, zeolites, individual citrates, carbonates, phosphates, and hydroxides of ammonium, sodium, potassium, calcium, zirconium or titanium. These materials are capable of extending the transient band over the firecone, being fire-retardants, which therefore increases reduced IP, or as combustion accelerators, to promote a complete incineration of the charred paper to produce white ash and improve cigarette appearance.

Additional criteria for PTM selection depend on the method of deposition of formulations on the paper. Compatibilities of different PTMs amongst themselves and with the paper are also important both for the process of deposition of formulation on paper, and for the reduced IP performance of such formulation. They can be classified as water dispersion or hot-melt systems which are below disclosed separately.

Water Dispersion Systems

Table 1 below shows non-limited examples of the developed formulations for the case of water-suspended PTMs. These formulations were prepared by blending micronized solid PTMs components into the 0.5-2.5% water solutions of surfactant (Tween-40, -60, -80, ethylene-bis-stearamide EBS, etc.). However, the practice of this invention is not limited to the Tween 80 surfactant, and may include any surfactants or their mixtures that enable water dispersions of hydrophobic and hydrophilic compounds and their blends.

TABLE 1

| | Concentration, % | | |
|---|---|---|---|
| | | | Range |
| TB useful property | Ingredient | Range used | preferred |
| Width controller low T | paraffin | 0-60 | 30-50 |
| Width controller high T | polypropylene | 0-40 | 20-30 |
| Vehicle, adhesive | carnauba | 0-50 | 2-30 |
| Diffusion control | polyethylene | 0-10 | 2-5 |
| High melt, surfactant | EBS* | 0-50 | 3-8 |
| Surfactant | Tween 80 | 0-0.5 | 0-0.5 |
| Solvent | water | 30-60 | 40-50 |

*ethylene-bis-stearamide

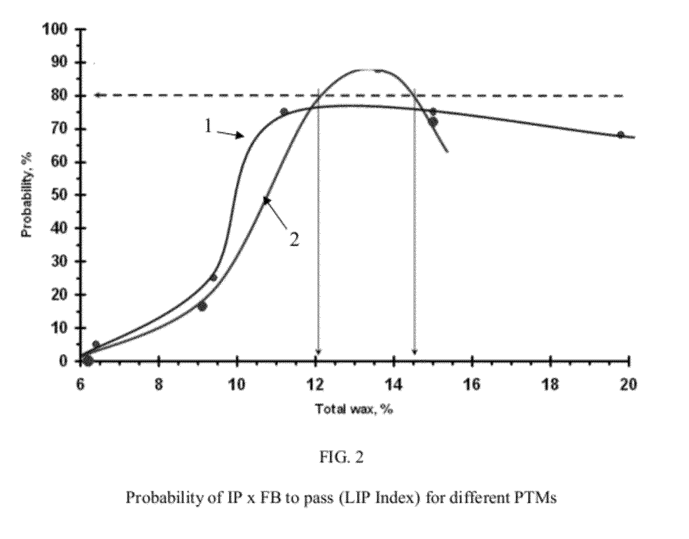

FIG. 2 shows the LIP index performance of cigarettes having conventional 19 CU wrapping paper treated with two different PTM formulations according to the present invention. The PTM formulations were deposited from water suspensions. As provided in FIG. 2, these exemplary PTM formulation embodiments of the present invention provide cigarettes with an improved LIP index performance compared to the prior art LIP fixed starch band cigarettes.

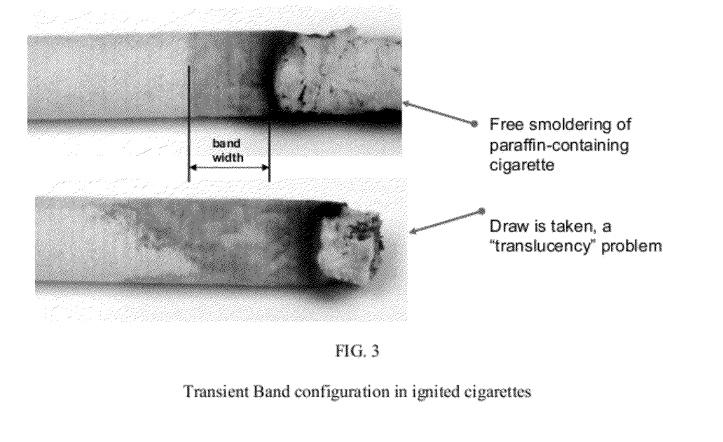

Along with LIP performance, applicants found that the selection of the ingredients for the PTM formulations determine the width of the transient band, which consists of a melted, translucent part and a charred part, as is shown in FIG. 3.

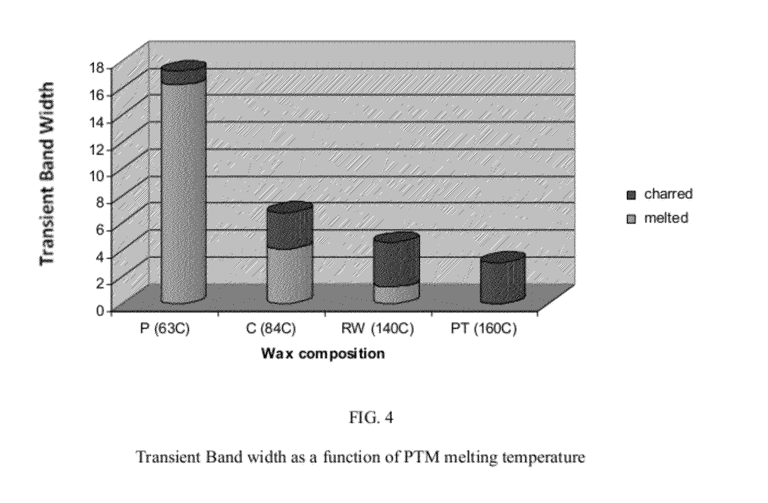

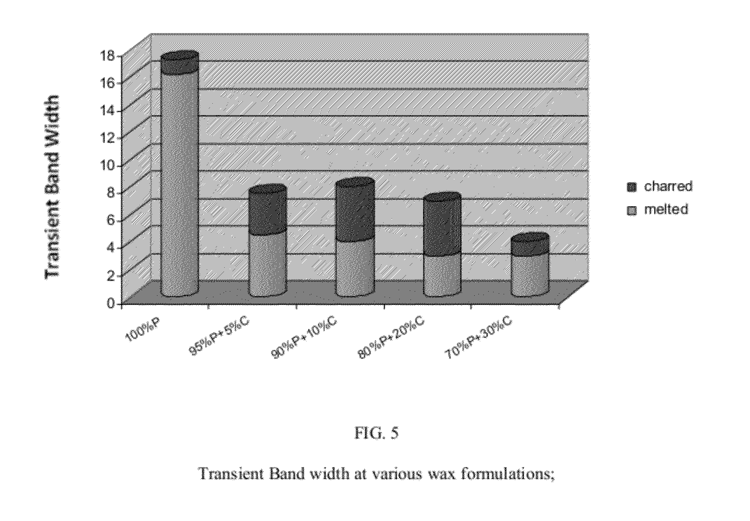

It was found that the transient band width decreases as the melting temperature of the PTM increases, as shown in FIGS. 4 and 5. It also shown in FIG. 4, it was further found that structure of the transient band varied based on the melting temperature of the PTM. Specifically, an increase in melting temperature of PTM resulted in beneficial effects of a decrease of the total width of the transient band and an increase of the charred area over firecone. An narrower or reduced transient band width provides a more acceptable appearance. An increase in the charred area provides a greater insulation layer between the burning firecone and an ignitable substrate. The PTMs used in the embodiments of the present invention illustrated in FIG. 4 are paraffin (P), carnauba (C), stearamide (RW) and polypropylene (PT). FIG. 5 illustrates the structure of transient band (i.e., melted part downstream of the firecone and charred part adjacent the firecone) on cigarettes having wrappers treated with paraffin (P) and varying concentrations of paraffin (P) and carnauba (C). Addition of carnauba to the low-melting temperature paraffin resulted in beneficial effects of decrease of the total length of transient band. Applicants have also found that burn retardants can also be used to effect the width of the transient band. For example, the use of di-ammonium phosphate (DAP), either as a component of the PTM formulation or as separately applied to the wrapper, decreases the transient band total width. However, the charred part of the transient band over firecone did not change. Applicants surmise that the DAP suppressed smolder of tobacco firecone, which, in turn, resulted in a lower firecone temperature and less heat generated to melt the PTM (e.g., paraffin). Therefore, a burn retardant can be used with a PTM (even a PTM having a lower melting temperature, such as paraffin) to control or limit the transient band width. The addition of a PTM having a higher melting temperature (e.g., carnauba) to the formulation decreases the transient band width on the cigarette, as seen in FIG. 5.

Hot Melt Systems

Table 2 provided below shows non-limited examples of the developed formulations for the case of hot melted PTMs. These formulations were prepared by co-melting the PTM ingredients and a surfactant.

TABLE 2

| | Concentration, % | | |
|---|---|---|---|
| | | | Range |
| VB useful property | Ingredient | Range used | preferred |
| Width controller high T | polypropylene | 0-100 | 10-25 |
| Vehicle, adhesive | carnauba | 0-100 | 40-50 |
| Diffusion control | polyethylene | 0-70 | 5-60 |
| High melt, surfactant | EBS | 0-45 | 30-40 |
| Low melt, flavorant | menthol | 0-40 | 5-35 |
| Surfactant | Tween 80 | 0.5-2 | 1-1.5 |

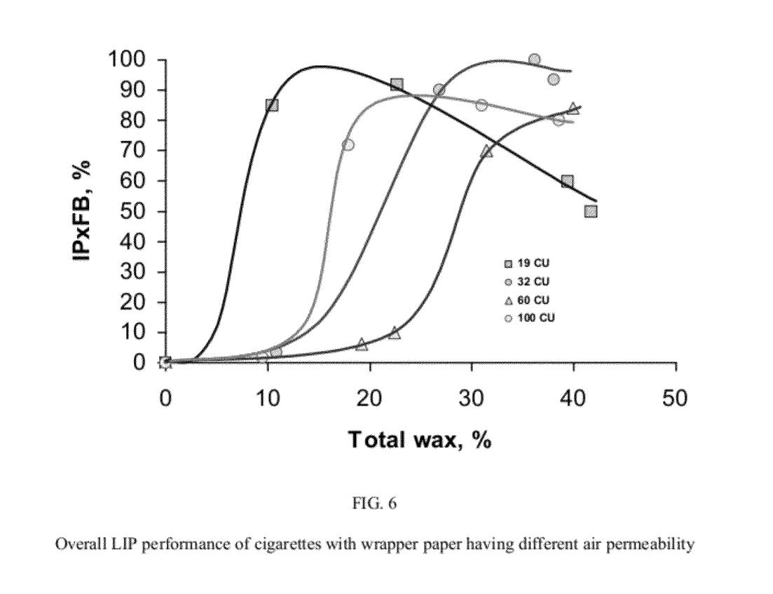

A carnauba and polyethylene hot melt PTM formulation was applied to a wide range of cigarette base papers having different pore size and pore distribution to demonstrate the broad applicability of the present invention. As illustrated in FIG. 6, the exemplary carnauba/polyethylene PTM formulation provided cigarettes with excellent LIP performance index properties. These examples demonstrate a robustness of the universal composition of carnauba and polyethylene, which achieves a LIP performance on different substrates.

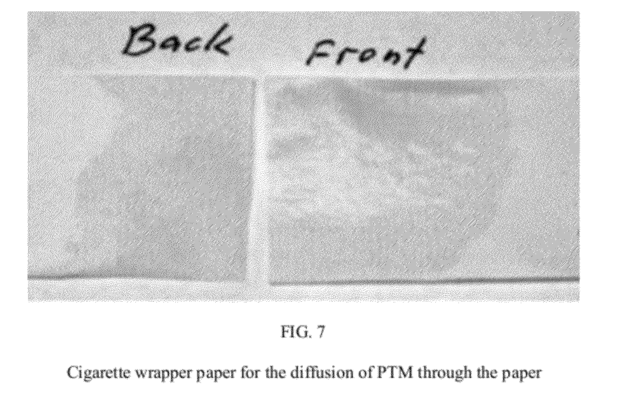

In one embodiment of the present invention, PTM formulations are composed of phase transfer ingredients, various ionic and/or non-ionic surfactants and with regard to water dispersion systems solvents as exemplified in Tables 1 and 2. These ingredients and their combinations are not limited. In these tables, the “Width controller at low T” or “—at high T” stand for a useful functions of expanding the transient band width towards cigarette filter (low temperature region), or over the firecone (high temperature region), respectively. The “Adhesive” is a property of some ingredients, which fixes PTM particles on the paper surface. The “Diffusion control” limits the diffusion of PTM ingredients through the paper, as illustrated by FIG. 7. The composition of PTMs determines whether melt stays inside cigarette or diffuses out; a finding confirmed by IR spectroscopy and microscopy. Formulation of polyethylene-polypropylene-carnauba (achieved reduced IP>95% and FB>95%) suggests an opportunity for improvement of appearance, producing a “hidden band.” The “Surfactant” creates stable colloid suspension of PTM in a chosen vehicle.

In addition to the discovered and disclosed ingredients of LIP formulations in water and hot melt systems, other materials, possessing special properties could be included during formulating, such as menthol and other flavorants, gels and gel-forming additives, clays, zeolites, rheology modifiers, tobacco extracts, tobacco wax, solanesol, adhesion controllers, appearance improvers, paper strength enforcers, flame retardants and other combustion controllers. Furthermore, combinations of different dispersions with melted PTM liquids can be used and provide new useful properties to the final LIP formulation.

Additionally, hydrophobic ingredients were discovered to be useful in formulations to control/minimize the adhesion between rolled layers of cigarette wrapper. Elimination of the unwanted adhesion was found to more important in the case of water suspension sprayed formulations, especially in the case of using hydrophilic PTMs, such as carnauba.

Applicants have also found that the hydrophobic or hydrophilic properties of PTMs play a major role in providing PTM formulations for cigarettes having outstanding LIP performance index. The hydrophilic PTMs (e.g., carnauba, stearyl alcohol, stearic acid and glyceryl stearate) can be used to provide adhesion of PTM formulation to the paper. The hydrophilic PTMs with relatively low melting points can be efficiently introduced on paper by spraying both hot melted formulations, and water suspensions. In the first case, the residual water can provide an additional benefit of vaporizing and absorbing some of combustion heat, thus promoting the LIP effect.

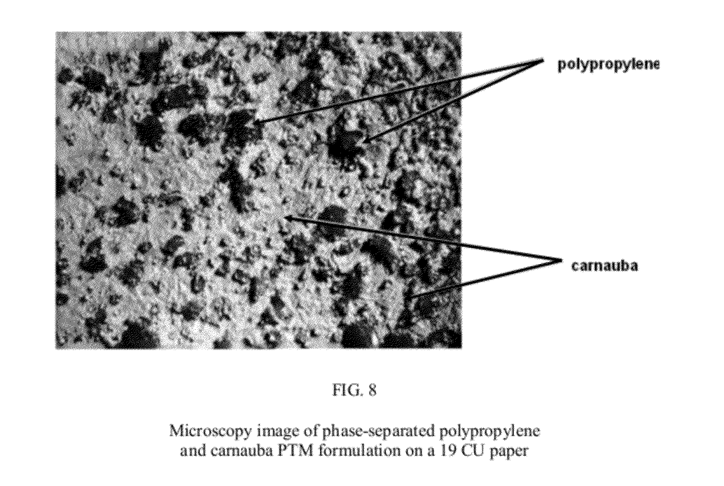

The hydrophobic PTMs (e.g., polypropylene, polyethylene, polymethylpentene, usually containing linear hydrocarbon chains) can be used to offset undesirable adhesive properties of hydrophilic ingredients in order to prevent an excessive stickiness of layers of rolled cigarette paper. The hydrophobic PTMs can be introduced on paper by spraying hot melted formulations, as seen in FIG. 8 which shows microscopy image of phase-separated PT+C PTM formulation on 19 CU paper. Homogeneous melted polypropylene and carnauba at ˜200° C. underwent fast cooling with sheering in the nozzle of sprayer Champ 10S. Large particles of polypropylene are clearly seen, separated from carnauba. Such PTMs are preferentially deposited from the water suspensions, where such macro-molecules are coiled and form easy deposited particles in the presence of surfactant.

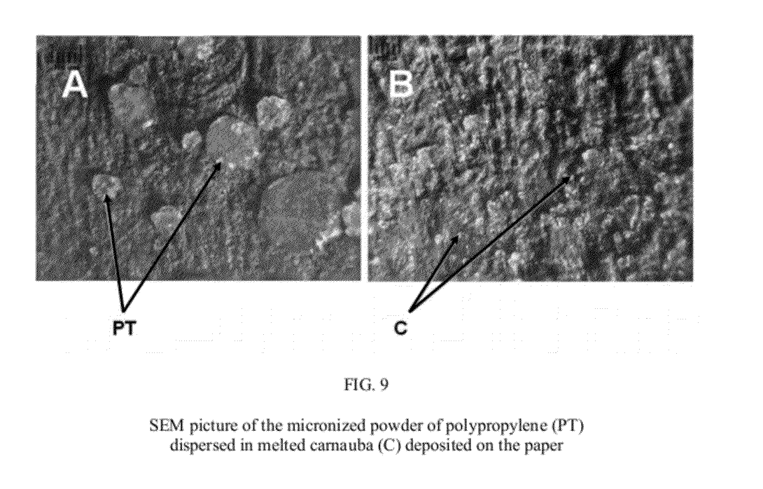

Applicants found that a PTM with high melting temperatures in solid form (e.g., fine powder) can be embedded into a PTM having a lower melting temperature to produce a heterogeneous PTM formulation, as shown in FIG. 9. Specifically, FIG. 9 is a SEM picture of micronized powder of polypropylene (PT) dispersed in melted carnauba (C) as deposited on the paper. The resulting reduced IP paper, therefore, may contain multiple phases. Upon melting, such a PTM forms transient bands having narrower width and improved appearance because the high melting temperature PTM components create a barrier to restrict the diffusion of the low melting temperature PTM components of the formulation.

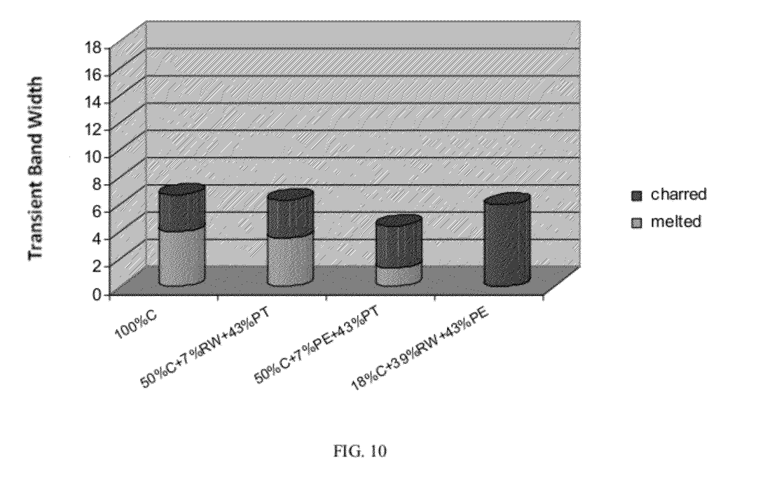

The appearance of transient band on a LIP cigarette where the PTM was applied using a hot-melt systems, as was shown above for the case of PTM deposition from water suspensions, also depends on the melting temperatures of the components of the PTM formulation. For reference, the general structure of the transient band on a cigarette is shown in FIG. 3. The addition of stearamide, polyethylene or polypropylene to a PTM having a relatively low melting temperature, such as carnauba, decreases the width of the melted part of transient band, whereas the charred part became wider and promotes LIP performance. This is illustrated in FIG. 10, which shows the transient band on LIP cigarettes made of mixed PTMs—modified papers. The addition of high melting temperature PTMs to carnauba decreased the melted area. Replacement of ethylene-bis-stearamide (RW) with polyethylene (PE) decreased the melted area of the transient band due to suppressed diffusion through the polyethylene (PE). The addition of polyethylene (PE) decreased the melted area, blocking the diffusion of carnauba (C) through the paper, and increased the charred area. It will be understood, that an increased charred area is generally beneficial to create an insulating layer adjacent the firecone to prevent the burning firecone from igniting an ignitable substrate with which it may contact.

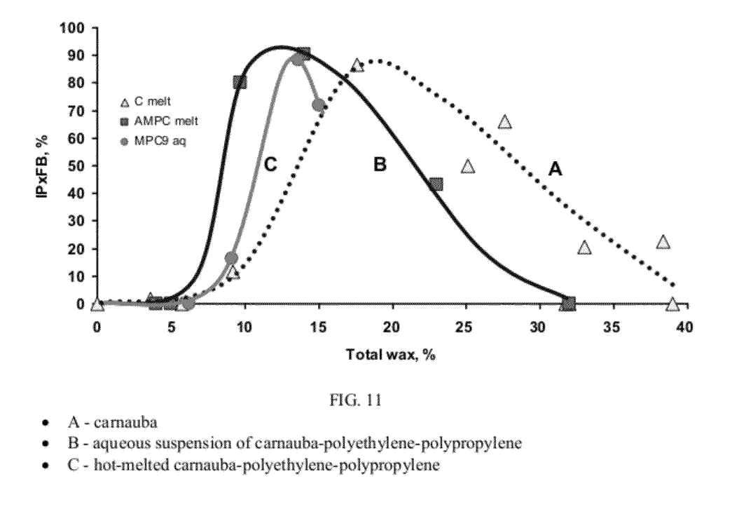

Applicants also discovered an improved appearance of the transient band with the addition of a high melting temperature PTM to the working formulation. The LIP performance of such cigarettes was found to be better than in the case of a mono-component formulation, as seen in FIG. 11. This required less applied PTM formulation, as shown in FIG. 11 which shows the reduced IP-FB performance of machine-made cigarettes with carnauba-polyethylene-polypropylene formulations deposited from water suspensions and from hot melts. Therefore, the content of PTM formulation can be used to tailor the desirable combustion properties of cigarettes as well as the cigarette smoke quality.

Shear-Induced Phase Separation

Applicants have discovered that the co-melted PTMs may undergo a shear induced as well as a falling temperature (after melted PTM left the spray nozzle) induced phase separation, which in general diminishes the homogeneity of multi-PTM alloys and continuum of a future transient band. A shear induced phase separation structure of PTM components is reduced by using compatible ingredients. Such reduction is beneficial for generating a continuous, sufficiently broad transient band, extended both toward the filter, and to the firecone. Such transient band structure is not facilitated by using less compatible or incompatible PTMs in formulation. Nonetheless, applicants have found that the use of incompatible PTMs may create phase-separated structures which offer some useful features, such inhibiting axial wicking. Such features include a control-modulation of transient band expansion to the cold region of the paper and control for the shape of the border line between melted PTMs to the intact paper region. The incompatibility of the PTMs may also prevent the unduly diffusion of PTM, deposited on one side through the paper to the other side when it's melted (inner to outer side of cigarette).

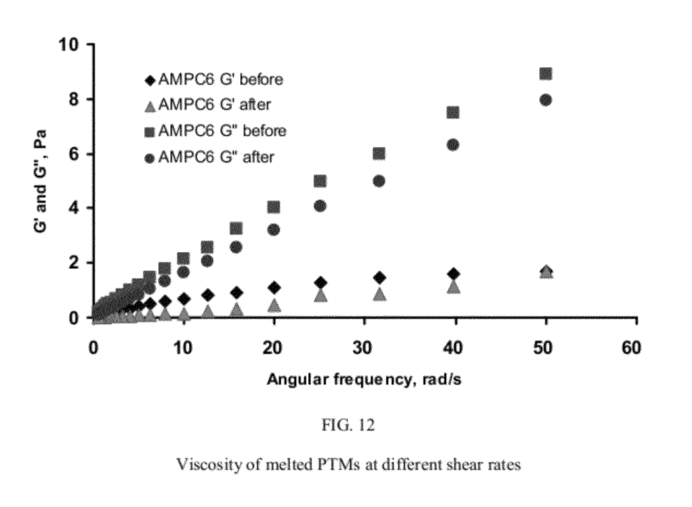

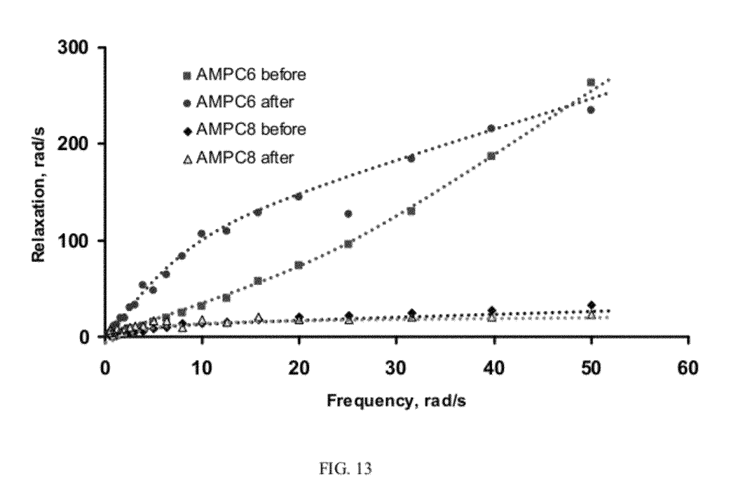

It was also discovered that the rheological properties of PTM formulations were critical, particularly, in regard to the hot melt spraying process. Results of measuring viscosity modules and calculating relaxation times of melted PTM formulations are shown in FIGS. 12 and 7, respectively. More specifically, FIGS. 12 and 13 shows the measurements of viscosity of melted PTMs at different shear rates of G-modules and relaxation rates (G″/G′)×ω, of polypropylene-carnauba-polyethylene (AMPC6) vs (B) carnauba-polyethylene-polypropylene (AMPC8) at 180° C. Measurements were taken before and after shear treatments at the same temperature using a rheometer AR2000ex, TA Instrument. These results reveal that the presence of a high melting temperature polypropylene PTM component in large proportion can transfer the melt into a solid-like state (or a liquid crystal-like), thus causing formation of fibers and other problems during hot melt spray process. The behavior of such liquid is a non-Newtonian-like, i.e., its viscous properties depend on a shear rate, for example in the spray nozzle. Thus the viscosity of the melted formulation with about 50% polypropylene is, in fact, unpredictable. Applicants formulated the PTM mixtures with less relative amounts of this PTM ingredient, which made the melted formulation to be more Newtonian and easy to spray on paper and discovered that those formulations also provided LIP performance.

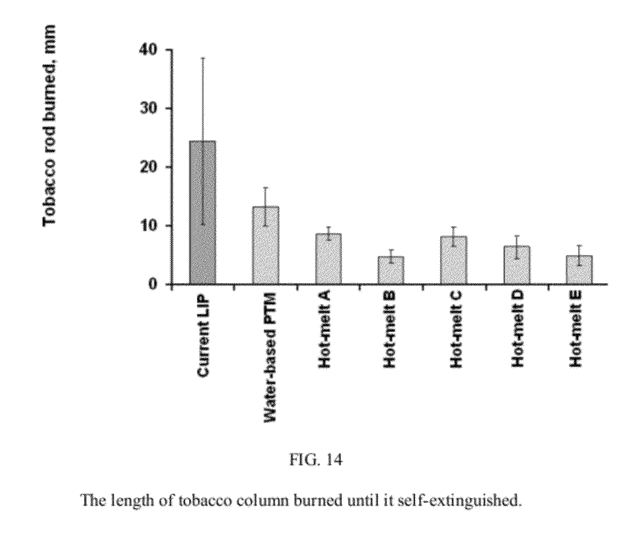

Surprisingly the PTM formulations of the present invention provide another beneficial feature to the LIP cigarette of a much faster rate of extinguishing and less standard deviation of the extinguishing rate between cigarettes as compared to the prior art current fixed starch band reduced IP cigarettes. This feature causes a shorter tobacco rod to be consumed before extinguishing and therefore, a greater protection for substrate, such as upholstery fabric on which a burning LIP cigarette is dropped, from catching fire. As shown in FIG. 14, the length of the tobacco column burned to the moment of were the cigarette extinguishes depends on the PTM composition, both for water-based and different hot-melt PTM formulations of the present invention as compared to the prior art fixed starch band cigarettes (designated “Current LIP”). With regard to FIG. 14, “Water-based PTM” is a PTM formulation having 16% carnauba, 24% polyethylene and 60% water; “Hot-melt A” is a PTM formulation having 55% carnauba, 35% polyethylene and 10% polypropylene; “Hot-melt B,” “Hot-melt C,” “Hot-melt D,” and “Hot-melt E” are PTM formulations having 50% carnauba, 29% polyethylene and 21% EBS. In addition, “Current LIP,” “Water-based PTM,” “Hot-melt A” and “Hot-melt B” used 19 Coresta Unit paper, “Hot-melt C” used 32 Coresta Unit paper, “Hot-melt D” used 60 Coresta Unit paper and “Hot-melt E” used 100 Coresta Unit paper.

PTM Compatibility

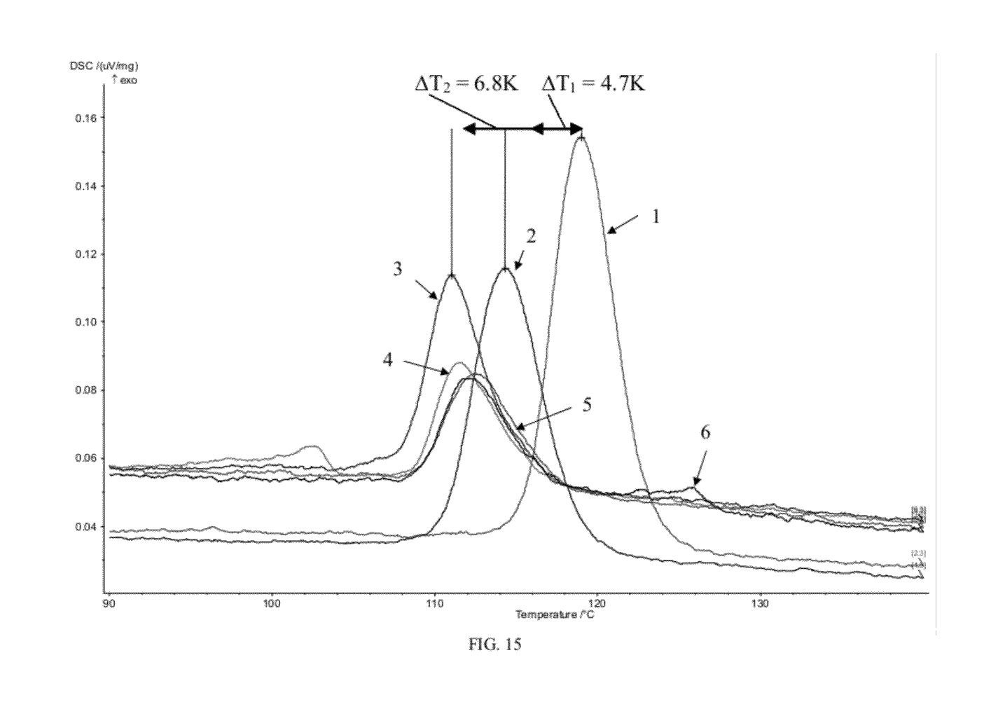

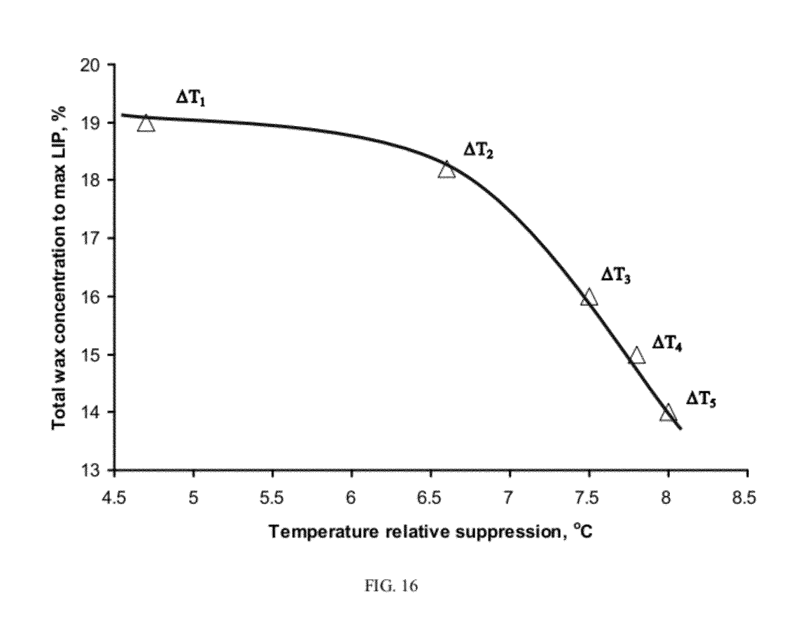

Measure of compatibility of PTMs was obtained from the heating-cooling-heating cycle of DSC spectra for the water suspension based formulations, which specifically showed the process of solidification of the liquid PTM cooled below melting point. The more compatible the PTMs were, the lower the temperature their melt could withstand before crystallization. As seen in FIG. 15, blending the PTMs caused a shift in the temperature of solidification while cooling of DSC chamber, tₛ=tₛ₁−tₛ₀. The applicants discovered that this shift resulted from the intrinsic properties of PTMs and correlate with the loading necessary for LIP effect, as shown in FIG. 16.

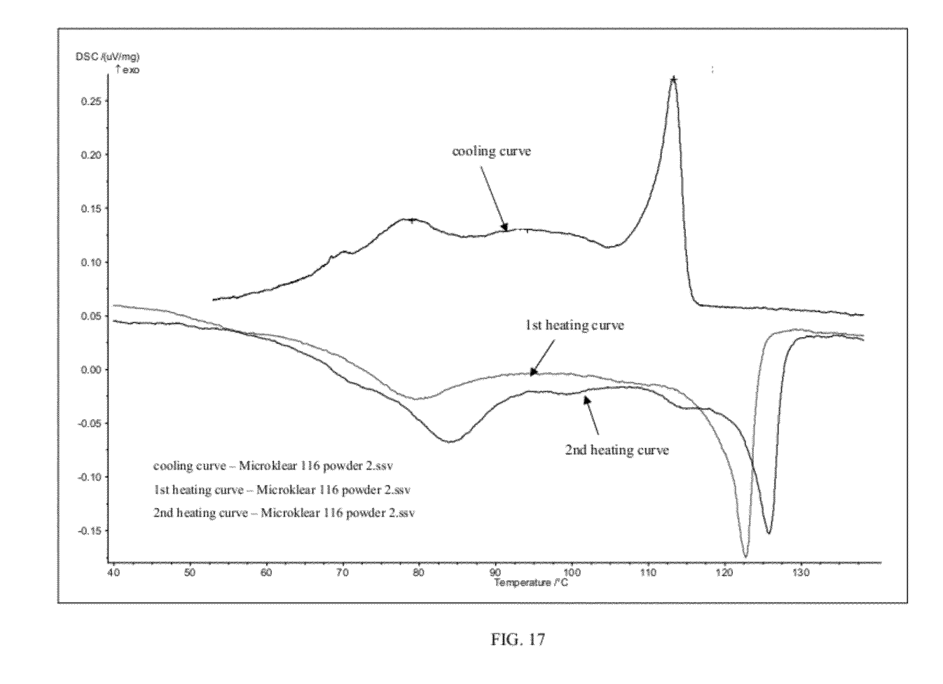

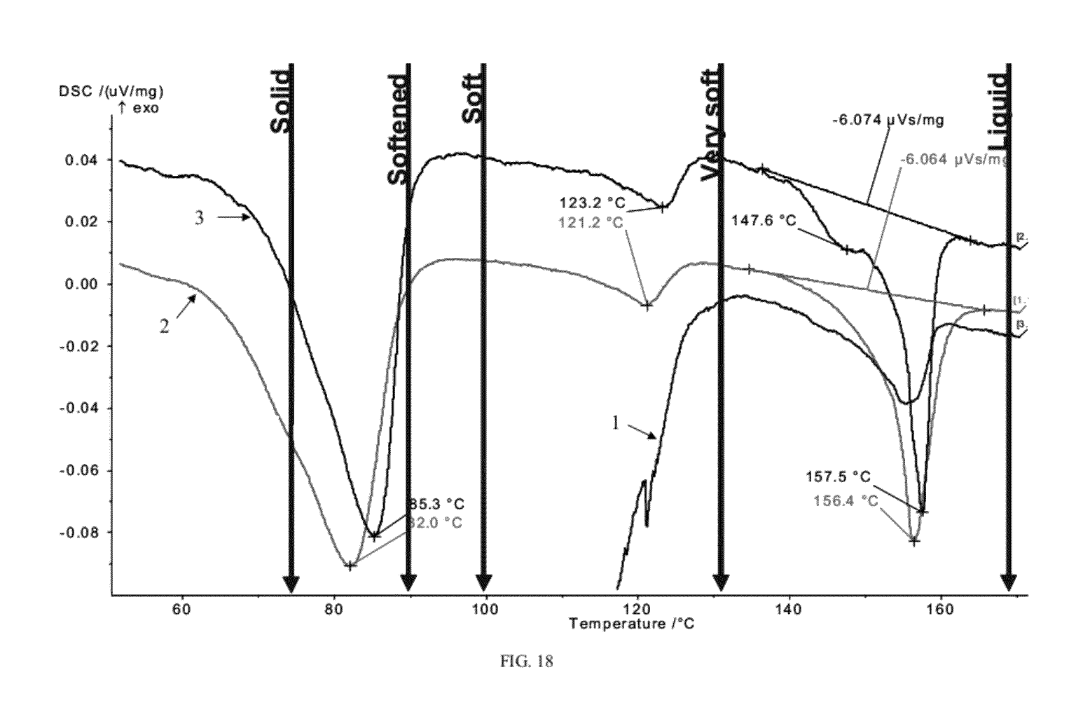

Similar criteria of PTMs compatibility, as for the water suspensions, determine the compositions of formulations delivered by spraying of the hot PTM melts. Interactions between compatible PTMs, as evident in FIG. 17, are important in terms of sprayability of hot melt formulations, where softening and melting of PTM were monitored versus temperature of formulation. In FIG. 17, compatibility is indicated as “unresolved” DSC peaks, which comprise about 32% and 60% eutectic mixtures for CPE and Microklear formulations of PTMs, respectively. An observed decrease in freezing temperature of about 13° C. is also evident of interactions between PTMs. FIG. 18 shows the melting of carnauba-polyethylene-polypropylene formulation in a 100° C. temperature range as monitored by DSC. This range covers all melting points. Spraying is possible above higher melting temperature, which may exert a thermo-stability concern. Therefore, mixture of the low compatibility PTMs becomes liquid and sprayable at the highest melting temperatures of components, included in the system as in FIG. 18, whereas the interacting PTMs, such as mixture of interacting carnauba and polyethylene liquefies at lower temperatures due to the formation of eutectic compounds, as seen in FIG. 17. In the latter case, the possibility of a lower temperature of PTM deposition on paper implies a greater stability of chemical content of a formulation during deposition process.

In addition to improvement to the ignition propensity and static free burn brought by the use of PTMs deposited in the tobacco column wrapper, the applicants also discovered a method to increase the TAR/CO ratio. “Total particulate matter” TAR is a primary component of tobacco smoke and carbon monoxide, CO, is a component of the gas phase. TAR affects taste and CO is a hazardous compound that the cigarette designers want to minimize. Therefore it would be desirable to increase the TAR/CO ratio of tobacco smoke.

The participants discovered that it is possible to increase the TAR/CO ratio by changing the conditions at which tobacco undergoes distillation, pyrolysis and combustion by applying phase transition materials (PTM) to the tobacco wrapper to control the air and smoke flow through the different components of the tobacco rod and the firecone.

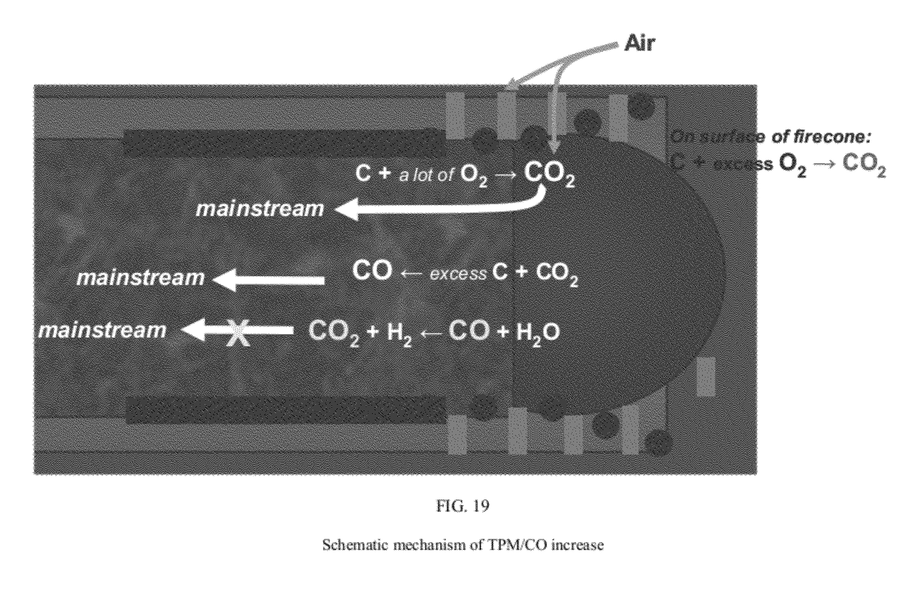

FIG. 19 shows a postulated mechanism to increase the TAR/CO ratio. Considering that the major reactions of carbon oxides in cigarette firecone which determine the yield of CO are the following:

Exothermic: C+air O₂→CO₂ (1)

Endothermic: char C+CO₂→CO (2)

Exothermic: CO+H₂O→CO₂+H₂ (3)

Therein reaction (1) takes place on the hot surface of firecone between excess of carbon in char and atmospheric oxygen. It generates most of the heat for all thermal processes in the cigarette. The formed CO₂ is partially delivered in smoke, but part of it reacts with the same carbon at even higher temperatures of around 1000° C. with formation of CO. This reaction is endothermic and drops the surrounding temperature to around 300° C., at which part of CO may still get oxidized by formed water back to CO₂. Relative rates of these reactions determine the yields of CO and to a great extent depend on the flow rates of air and smoke through hot zone of firecone.

Redirecting the inlet air from the firecone to the charline diminishes the rate of reaction (2) and CO formation and effectively decreases CO yield, or increases TPM/CO ratio. Therefore, the control over the relative rates of those three reactions provides control over TPM/CO ratio in smoke, which was accomplished by depositing PTM particles on cigarette paper. In addition, PTMs for this application can be incorporated also in the paper matrix.

During smoking, the wax particles are melted by the approaching firecone. As the firecone moves along the tobacco column, it causes vaporization and diffusion of PTMs into the fiber net, therefore opening additional channels for air access to the firecone. As a result, a greater part of air puff is channeled through the char line area rather than through firecone. This slows the gas flow through firecone and decreases reaction for formation of CO₂ (1) and its reduction by C (2) with formation of CO. The decrease in gas flow through firecone partially suppresses CO formation and increases TPM/CO.

Below are several non-limiting examples of the use of TPM to increase the TAR/CO ratio.

### Example 1

### Tobacco Wax (100% Solanesol)

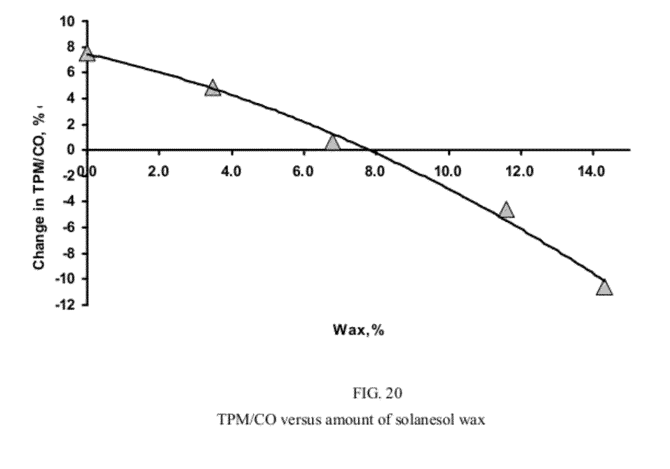

The addition of 1-5% of solanesol wax on the 19 Coresta Units cigarette paper increases the TPM/CO ratio of treated cigarette by up to 7% as compared to commercial cigarette, as seen in FIG. 20. Higher concentrations of solanesol block much of paper pores. Thus CO yield increases faster than TPM, therefore decreasing TPM/CO.

### Example 2

### CPE Wax Formulation (55% Carnauba, 45% Polyethylene)

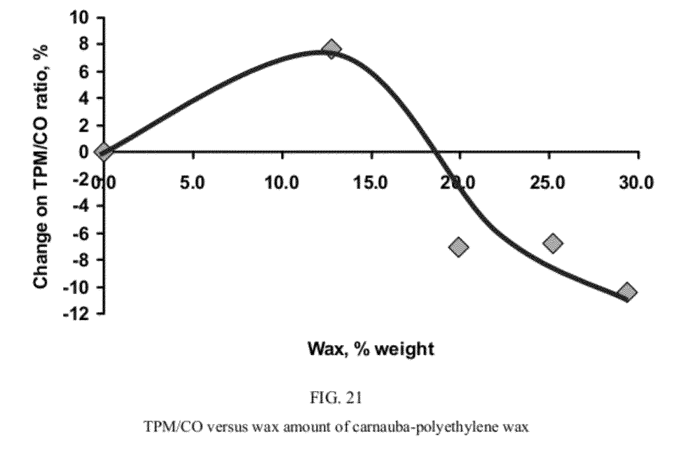

The addition of 10-17% of carnauba-polyethylene (CPE) wax on the 19 Coresta Units cigarette paper increases the TPM/CO ratio of treated cigarette by up to 8% as compared to commercial cigarette, as seen in FIG. 21. Higher concentrations of CPE wax block much of paper pores. Thus CO yield increases faster than TPM, therefore decreasing TPM/CO.

### Example 3

### SPEC Wax Formulation (55% Carnauba, 35% Polyethylene, 10% Solanesol)

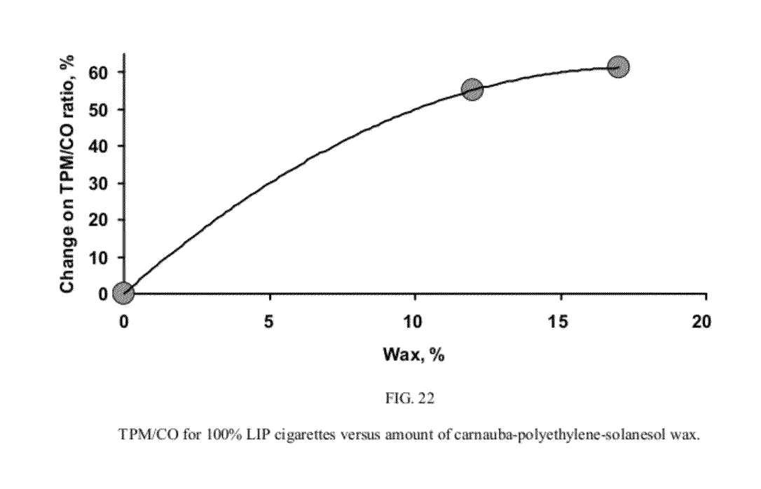

A synergetic effect of large increase in TPM/CO ration we discovered as a result of the interaction between components of wax formulation. The addition of 10-17% of carnauba-polyethylene-solanesol (SPEC) wax on the 19 Coresta Units cigarette paper increases the TPM/CO ratio of treated cigarette by up to 60% vs commercial cigarette, as seen in FIG. 22.

Applicants have also discovered that ingredients, which usually serve as flavor additives to a cigarette, can simultaneously be used as constituents of PTM formulations for LIP design. Thus, menthol was found to be a beneficial ingredient, providing quality parameters as well as (i) a flavor supplied to cigarette along with (ii) the formation of much lower melted eutectic compound as a result of interaction between carnauba and menthol. Many other flavorants can also be added to the aforementioned PTM formulations and subsequently applied to the cigarette paper. Thus, in this manner, it is possible to impart a flavor to the mainstream smoke upon use. Therefore, this invention provides a beneficial method to impart flavor such as menthol to a cigarette. A particular benefit of adding flavorant to the PTM is the ability to trigger and control the release of the flavorant once the PTM material is melted by the heat generated from the firecone during smoking. This aspect of the invention limits and/or inhibits the migration of the flavorants with high vapor pressure during storage, and thus minimizes the reduction in concentration of the flavorant over time.

What is claimed is:

1. A composition for application to a paper having a porous structure with a base permeability to create a smoking article wrapper for surrounding a tobacco column, the composition comprising:
(a) at the one phase transition substance which, upon being exposed to the heat produced by a burning firecone of the tobacco column, at least partially fills the wrapper porous structure in the vicinity of the burning firecone to form an area of the wrapper having a reduced permeability that is lower than the paper base permeability;
wherein the reduced permeability of the wrapper in the vicinity of the firecone permits sufficient air flow through the wrapper to sustain free burn, but, when the smoking article is placed on a substrate, the reduced permeability of the wrapper in the vicinity of the wrapper imparts reduced ignition propensity such that there is insufficient air flow to sustain combustion of the firecone or insufficient air flow to sustain an intensity of the burning firecone necessary to ignite the substrate.

2. The composition according to claim 1, wherein the at least one phase transition substance comprises one or more waxes.

3. The composition according to claim 2, wherein the one or more waxes comprises a natural wax, a synthetic wax, a microcrystalline wax or combinations thereof.

4. The composition according to claim 1, wherein the at least one phase transition substance comprises a formulation comprising a carnauba wax, a polyethylene wax and a polypropylene wax.

5. The composition according to claim 4, wherein the formulation comprises between about 45 to about 65 percent concentration of carnauba wax, between about 20 to about 40 percent concentration polyethylene wax and between about 5 to 15 percent concentration polypropylene wax.

6. The composition according to claim 5, wherein the polypropylene wax comprises a molecular weight about between 500 to about 1000 Mn.

7. The composition according to claim 5, wherein the polyethylene wax comprises a molecular weight about between 3500 to about 4500 Mn.

8. The composition according to claim 1, wherein the at least one phase transition material comprises paraffin wax and a carnauba wax.

9. The composition according to claim 1, wherein the composition further comprises a surfactant.

10. The composition according to claim 1, wherein the composition further comprises a burn retardant.

11. The composition according to claim 11, wherein the burn retardant comprises di-ammonium phosphate.

12. A wrapper for surrounding a tobacco column to create a smoking article having reduced ignition propensity, the wrapper comprising:
(a) a porous structure having a base permeability; and
(b) a surface of the wrapper treated with a composition comprising at the one phase transition substance which, upon being exposed to the heat produced by a burning firecone of the tobacco column, at least partially fills the wrapper porous structure in the vicinity of the burning firecone to form an area of the wrapper having a reduced permeability that is lower than the paper base permeability;
wherein the reduced permeability of the wrapper in the vicinity of the firecone permits sufficient air flow through the wrapper to sustain free burn, but, when the smoking article is placed on a substrate, the reduced permeability of the wrapper in the vicinity of the wrapper imparts reduced ignition propensity such that there is insufficient air flow to sustain combustion of the firecone or insufficient air flow to sustain an intensity of the burning firecone necessary to ignite the substrate.

13. A smoking article having reduced ignition propensity comprising:
(a) a tobacco column;
(b) a wrapper surrounding the tobacco column and having a porous structure with a base permeability;
(c) a composition treated on a surface of the wrapper, the composition comprising at the one phase transition substance which, upon being exposed to the heat produced by a burning firecone of the tobacco column, at least partially fills the wrapper porous structure in the vicinity of the burning firecone to form an area of the wrapper having a reduced permeability that is lower than the paper base permeability, wherein the reduced permeability of the wrapper in the vicinity of the firecone permits sufficient air flow through the wrapper to sustain free burn, but, when the smoking article is placed on a substrate, the reduced permeability of the wrapper in the vicinity of the wrapper imparts reduced ignition propensity such that there is insufficient air flow to sustain combustion of the firecone or insufficient air flow to sustain an intensity of the burning firecone necessary to ignite the substrate.

14. The smoking article according to claim 13, wherein the at least one phase transition substance comprises one or more waxes.

15. The smoking article according to claim 14, wherein the one or more waxes comprises a natural wax, a synthetic wax, a microcrystalline wax or combinations thereof.

16. The smoking article according to claim 13, wherein the at least one phase transition substance comprises a formulation comprising a carnauba wax, a polyethylene wax and a polypropylene wax.

17. The smoking article according to claim 16, wherein the formulation comprises between about 45 to about 65 percent concentration of carnauba wax, between about 20 to about 40 percent concentration polyethylene wax and between about 5 to 15 percent concentration polypropylene wax.

18. The smoking article according to claim 13, wherein a population of the smoking articles exhibits a LIP index defined as the product of the free burn success rate and the ignition propensity success rate that exceeds about 90%.

19. The smoking article according to claim 18, wherein the population of smoking articles is at least about 10 smoking articles.

20. The smoking article according to claim 18, wherein the population of smoking articles is between about 20 and 40 smoking articles.
